(19) United States
(12) Patent Application Publication
(10) Pub. No.: US 2013/0311502 A1
(43) Pub. Date: Nov. 21, 2013

(54) CASE SEARCHING APPARATUS AND CASE SEARCHING METHOD

(71) Applicant: Panasonic Corporation, Osaka (JP)

(72) Inventors: Kazutoyo TAKATA, Osaka (JP); Takashi TSUZUKI, Osaka (JP); Kazuki KOZUKA, Fukui (JP)

(73) Assignee: Panasonic Corporation, Osaka (JP)

(21) Appl. No.: 13/950,386

(22) Filed: Jul. 25, 2013

Related U.S. Application Data
(63) Continuation of application No. PCT/JP2011/006724, filed on Nov. 30, 2011.

(30) Foreign Application Priority Data
Jan. 31, 2011 (JP) 2011-019107

(51) Int. Cl. G06F 17/30

(52) U.S. Cl. CPC G06F 17/30253
USPC 707/758

(57) ABSTRACT

A case searching apparatus includes: an image similarity degree determining unit which calculates an image similarity degree between a first interpretation target image data item obtained by an interpretation target obtaining unit and a second interpretation target image data item registered in a case database; a text similarity degree determining unit which calculates the text similarity degree between a first image interpretation information item obtained by the interpretation target obtaining unit and the second image interpretation information item registered in the case database; and a different-text case searching unit which preferentially search out one or more case data items included in the case data items stored in the case database in a descending order of image similarity degrees determined by the image similarity degree determining unit and an ascending order of text similarity degrees determined by the text similarity degree determining unit.

### CROSS REFERENCE TO RELATED APPLICATIONS

This is a continuation application of PCT International Application No. PCT/JP2011/006724 filed on Nov. 30, 2011, designating the United States of America, which is based on and claims priority of Japanese Patent Application No. 2011-019107 filed on Jan. 31, 2011. The entire disclosures of the above-identified applications, including the specifications, drawings and claims are incorporated herein by reference in their entirety.

### FIELD

One or more exemplary embodiments disclosed herein relate generally to a case searching apparatus which automatically presents a reference case for an interpretation target case, and a case searching method performed by the case searching apparatus.

### BACKGROUND

Patent Literature 1 proposes a method of searching out and presenting a similar case using image feature quantities of a captured image corresponding to an image interpretation report stored in a database and text information included in the interpolation target report.

### CITATION LIST

### Patent Literature

### [PTL 1]

Japanese Unexamined Patent Application Publication No. 2009-093563

### SUMMARY

### Technical Problem

However, the method disclosed in PTL 1 does not provide any idea of presenting a similar case having diagnostic details different from details in a diagnosis made by a user.

In order to search out such a similar case having different diagnostic details using the method disclosed in PTL 1, various kinds of keywords different from keywords extracted from diagnostic details determined by a doctor need to be used in the search. The number of various kinds of keywords is extremely large. For this reason, the conventional method requires a large processing load for searching such a similar case having different diagnostic details.

The present disclosure relates to a case searching apparatus capable of searching out, with a small processing load, a similar case having diagnostic details different from details in a diagnosis made by a user, and a case searching method performed by the case searching apparatus.

### Solution to Problem

In one general aspect, the techniques disclosed here feature a case searching apparatus including: an interpretation target obtaining unit configured to obtain an interpretation target image data item indicating a medical image which is an interpretation target image and a first image interpretation information item including a text data item indicating a user's interpretation of the interpretation target image data item; an image similarity degree determining unit configured to determine an image similarity degree between the interpretation target image data item obtained by the interpretation target obtaining unit and an image data item indicating a medical image included in one of case data items stored in a case database; a text similarity degree determining unit configured to determine a text similarity degree between the first image interpretation information item obtained by the interpretation target obtaining unit and a second image interpretation information item including a text data item indicating an interpretation of the image data item included in the case data item stored in the case database; a different-text case searching unit configured to preferentially search out, from among the case data items stored in the case database, one or more case data items in a descending order of image similarity degrees determined by the image similarity degree determining unit and an ascending order of text similarity degrees determined by the text similarity degree determining unit; and an output unit configured to output, to outside of the case searching apparatus, the one or more case data items searched out by the different-text case searching unit.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Additional benefits and advantages of the disclosed embodiments will be apparent from the Specification and Drawings. The benefits and/or advantages may be individually obtained by the non-limiting exemplary embodiment and features disclosed in the Specification and Drawings, which need not all be provided in order to obtain one or more of such benefits and/or advantages.

### Advantageous Effects

The case searching apparatus and the case searching method according to the one non-limiting exemplary embodiment or features disclosed herein make it possible to search out, with a small processing load, a similar case having diagnostic details different from details in a diagnosis made by a user.

### BRIEF DESCRIPTION OF DRAWINGS

These and other advantages and features will become apparent from the following description thereof taken in conjunction with the accompanying Drawings, by way of non-limiting examples in the embodiment disclosed herein.

FIG. 1 is a block diagram showing a unique functional structure of a case searching apparatus according to an embodiment of the present disclosure.

FIG. 2 is a diagram showing an example of case data item stored in a case database.

FIG. 3 is a flowchart of overall processes performed by the case searching apparatus according to the embodiment.

FIG. 4 is a flowchart of detailed processes of a text similarity degree calculation process (Step S103 in FIG. 3).

FIG. 5 is a diagram showing an example of a matrix.

FIG. 6 is a diagram showing an example of a conversion table.

FIG. 7 is a diagram showing an example of a matrix obtained by adding diagnosis levels to the matrix in FIG. 5.

FIG. 8 is a block diagram showing a unique functional structure of the case searching apparatus when connected to an image threshold value database provided outside of the case searching apparatus.

FIG. 9 is a diagram showing an example of data stored in the image similarity degree threshold value database.

FIG. 10 is a diagram showing an example of a similarity degree to text difference degree conversion table.

FIG. 11 is a diagram showing an example of a display screen output onto an output medium by an output unit.

FIG. 12 is a diagram showing an example of a display screen output onto the output medium by the output unit.

FIG. 13 is a diagram showing an example of a display screen output onto the output medium by the output unit.

FIG. 14 is a block diagram showing a hardware structure of a computer system which realizes the case searching apparatus.

### DESCRIPTION OF EMBODIMENT

### (Underlying Knowledge Forming Basis of the Present Disclosure)

In relation to the conventional method disclosed in the Background section, the inventors have found the problem below.

Recently, in a medical diagnosis field, it is becoming easier for doctors to share a large amount of data with an advancement of digitalization of captured images and image interpretation reports. Here, an image interpretation report is a text information item indicating a diagnosis made by an image interpreter based on a captured image. In addition, image interpretation reports stored in Picture Archiving and Communication Systems (PACS) which are systems for storing and communicating images are managed in an associated manner, and the stored past image interpretation reports are desired to be used secondary in an effective manner. A method for using such image interpretation reports secondary is to automatically present reference cases for an interpretation target image based on which a diagnosis is made. In relation to this, an effort for supporting a decision making related to a diagnosis is expected.

As a conventional technique for realizing presentation of such reference cases, Patent Literature 1 proposes a method of searching out and presenting a similar case using image feature quantities of a captured image corresponding to an image interpretation report stored in a database and text information included in the interpolation target report. More specifically, the method is intended to extract a representative keyword between text information items of image interpretation reports indicating similar mage states when searching reference cases, select image feature quantities associated with the extracted keyword, and calculate a similarity degree between the current case and each of the reference cases based on the selected image feature quantities. The text information items described in the image interpretation reports show viewpoints focused by image interpreters. In other words, the method disclosed in PTL 1 makes it possible to present the representative similar case based on the image feature quantities focused commonly by many image interpreters.

However, the method disclosed in PTL 1 does not provide any idea of presenting a similar case having diagnostic details different from details in a diagnosis made by a user.

A similar case having different diagnostic details is a case for which a diagnosis different from a user's diagnosis was made although image states between the cases are similar to each other. For example, when a doctor diagnoses a disease in a case shown by an image as “A cancer”, cases of diseases diagnosed as “B cancer” and “C cancer” despite similar image states are the cases in point. With these searched-out similar cases having different diagnostic details, the image interpreter can easily check a plurality of confusing cases by comparing the diagnosis made by himself or herself and the diagnoses in the presented similar cases. For this reason, it is possible to reduce the risk of a misdiagnosis.

In order to search out such a similar case having different diagnostic details using the method disclosed in PTL 1, various kinds of keywords different from keywords extracted from diagnostic details determined by a doctor need to be used in the search. The number of various kinds of keywords is extremely large. For this reason, the conventional method requires a large processing load for searching such a similar case having different diagnostic details.

The present disclosure relates to a case searching apparatus capable of searching out, with a small processing load, a similar case having diagnostic details different from details in a diagnosis made by a user, and a case searching method performed by the case searching apparatus

Hereinafter, an embodiment of the present disclosure is described in detail with reference to the drawings. It is to be noted that the embodiment described below is a non-limiting specific example in the present disclosure. The numerical values, structural elements, the arrangement and connection of the structural elements, steps, the processing order of the steps etc. shown in the following exemplary embodiment are mere examples, and therefore do not limit the scope of the present disclosure. Therefore, among the structural elements in the following exemplary embodiment, structural elements not recited in any one of the independent claims which define the generic concept of the present disclosure are described as arbitrary structural elements.

First, terms having special meanings in this embodiment are defined below. In this embodiment, a similar case is defined as a case involving an image similar in shape features (as mentioned above), and is a generic concept of a different-text case and a similar-text case. The “different-text case” is defined as a case involving an image similar in shape features to an image interpreted by a user (an image interpreter such as a doctor) but having diagnostic details different from diagnostic details in a case involving the interpreted image. On the other hand, the “similar-text case” is defined as a case involving an image similar in shape features to the image interpreted by the user and having diagnostic details similar to the diagnostic details in the case involving the interpreted image.

There are two kinds of methods for supporting diagnoses based on image interpretation using similar cases.

One of the method is a supporting method for presenting similar-text cases for an interpretation target case, as shown in PTL 1. The image interpreter checks whether or not any diagnosis similar to a diagnosis made by himself or herself is made by comparing his or her diagnosis with the diagnosis in the similar case. This supporting method makes it possible to increase a reliability on the diagnosis by the image interpreter. For this reason, the method provides an effective support to image interpreters who have little image interpretation experience and thus are less confident on diagnoses.

The other method is a supporting method for presenting different-text cases for an interpretation target case. For example, this method is intended to actively present, when a doctor diagnoses a disease in a case shown by an image as “A cancer”, cases of diseases diagnosed as “B cancer” and “C cancer” despite similar image states. According to this method, the image interpreter can easily check a plurality of confusing cases by comparing the diagnosis made by himself or herself and the diagnosis in the presented different-text cases. For this reason, it is possible to reduce the risk of a misdiagnosis by the image interpreter.

The case searching apparatus according to this embodiment is an apparatus for searching a different-text case for a case shown by a medical image interpreted by a user. The medial image is, for example, an ultrasound image, a Computed Tomography (CT) image, or a nuclear magnetic resonance image.

In one general aspect, the techniques disclosed here feature a case searching apparatus including: an interpretation target obtaining unit configured to obtain an interpretation target image data item indicating a medical image which is an interpretation target image and a first image interpretation information item including a text data item indicating a user's interpretation of the interpretation target image data item; an image similarity degree determining unit configured to determine an image similarity degree between the interpretation target image data item obtained by the interpretation target obtaining unit and an image data item indicating a medical image included in one of case data items stored in a case database; a text similarity degree determining unit configured to determine a text similarity degree between the first image interpretation information item obtained by the interpretation target obtaining unit and a second image interpretation information item including a text data item indicating an interpretation of the image data item included in the case data item stored in the case database; a different-text case searching unit configured to preferentially search out, from among the case data items stored in the case database, one or more case data items in a descending order of image similarity degrees determined by the image similarity degree determining unit and an ascending order of text similarity degrees determined by the text similarity degree determining unit; and an output unit configured to output, to outside of the case searching apparatus, the one or more case data items searched out by the different-text case searching unit.

With this, the user can search out the similar case involving a similar image but having diagnostic details different from details in the diagnosis by himself or herself with a small processing load. Therefore, the user can easily check a plurality of confusing cases. For this reason, it is possible to reduce the risk of a misdiagnosis.

More specifically, the different-text case searching unit may be configured to search out, from among the case data items stored in the case database, the one or more case data items each of which has a value indicating a text difference degree and larger than a predetermined threshold value for text difference degrees, the value being obtained by dividing the image similarity degree determined by the image similarity degree determining unit by the text similarity degree determined by the text similarity degree determining unit.

By defining the text difference degree as such, it is possible to simultaneously evaluate the image similarity degree and the text similarity degree.

In addition, the different-text case searching unit may be configured to narrow down the case data items stored in the case database to one or more case data items each including a second image interpretation information item which does not include a disease name included in the first image interpretation information item obtained by the interpretation target obtaining unit, and preferentially search out the one or more case data items in the descending order of the image similarity degrees determined by the image similarity degree determining unit and the ascending order of the text similarity degrees determined by the text similarity degree determining unit.

Presentation of cases of the same diseases as the disease diagnosed by the user inevitably increases reference time for search results by the user. Thus, presentation of only different-text cases of diseases different from the disease diagnosed by the user reduces reference time for search results by the user, which leads to reduce diagnosis time required for the user.

In addition, the different-text case searching unit may be configured to narrow down the case data items stored in the case database to one or more case data items whose image similarity degrees determined by the image similarity degree determining unit are larger than or equal to a threshold value for the image similarity degrees, and preferentially search out the one or more case data items in the descending order of the image similarity degrees determined by the image similarity degree determining unit and the ascending order of the text similarity degrees determined by the text similarity degree determining unit.

By narrowing down the case data items stored in the case database to the search-target case data items having a similarity degree larger than or equal to the threshold value for the image similarity degrees, and searching out the one or more case data items from the search-target case data items, it is possible to reduce the number of search-target case data items. Therefore, it is possible to reduce search time.

In addition, the threshold value for the image similarity degrees may be determined according to the number of pixels of the interpretation target image data item obtained by the interpretation target obtaining unit.

More specifically, the threshold value for the image similarity degrees may increase with increase in the number of pixels of the interpretation target image data item obtained by the interpretation target obtaining unit.

The image similarity degrees tend to become smaller with increase in the number of pixels representing the first interpretation target image data due to individual differences in the positions and sizes of organs and blood vessels whose images are to be captured. On the other hand, when the first interpretation target image data is image data of a local area such as a lesion portion of a liver, the image similarity degrees tend to be larger due to a reduced influence of the individual differences. For this reason, by defining the threshold value related to the image similarity degree as described above, it is possible to select an appropriate threshold value depending on the size of the first interpretation target image data, and to thereby search out an appropriate different-text case.

In addition, the text similarity degree determining unit may be configured to add a large weight to a word related to a disease name, and determine a weighted text similarity degree between the first image interpretation information item and the second image interpretation information item.

By calculating the text similarity degree with weights to the keywords related to the disease names, it is possible to calculate the similarity degree based on the user's viewpoints.

In addition, the text similarity degree determining unit may be configured to determine a text similarity degree between a set of the first image interpretation information item and a first diagnosis level which is determined based on the first image interpretation information item and a set of the second image interpretation information item and a second diagnosis level which is determined based on the second image interpretation information item, each of the first and second diagnosis levels being an indicator of a classified disease stage.

The diagnosis levels are keywords which correspond to the generic concepts of disease names and are as important as the disease names for the user because the keywords represent differences between cases. With this structure, it is possible to calculate the text similarity degree reflecting the differences of the diseases stages.

In addition, the text similarity degree determining unit may further be configured to determine the diagnosis level from a text item included in each of the first image interpretation information item and the second image interpretation information item with reference to a conversion table for converting a text item included in an image interpretation information item to a diagnosis level.

The use of the conversion table makes it possible to easily convert a text item into a diagnosis level.

More specifically, each of the first and second diagnosis levels may be one of (i) “No finding” indicating that there is no abnormal finding, (ii) “Follow-up” indicating that careful follow-up of a disease state is required, (iii) “Other test” indicating that an other test is required, and (iv) “Biopsy” indicating that a medical test using a microscope is required to examine an extracted part of a lesion.

In addition, the output unit may be configured to classify the one or more case data items searched out by the different-text case searching unit for each kind of disease names, and output the classified case data items to the outside of the case searching apparatus.

The user needs to find out disease descriptions different from the diagnosis by himself or herself from the findings in the search results when considering a possibility of a disease other than the disease as the result of the diagnosis by himself or herself. By presenting a display screen classified for the respective kinds of disease names as the search results, the user can easily check the disease names in the cases presented as the search results, and can reduce image interpretation time.

In addition, the output unit may be configured to output, in distinguishable modes, the first image interpretation information item obtained by the interpretation target obtaining unit and the second image interpretation information item included in each of the one or more case data items searched out by the different-text case searching unit.

By outputting, in distinguishable modes, these difference information items, the user can easily check the basis for the text difference degree, and can reduce image interpretation time after the check.

In addition, the different-text case searching unit may be configured to search out the one or more case data items from case data items including a second image interpretation information item in which an image finding and a definitive diagnosis match among the case data items stored in the case database, the image finding may be obtained when the user makes a diagnosis based on the image data item included in the case data item, and the definitive diagnosis may be a definitive diagnosis made based on the image data item included in the case data item.

The case database includes the image data items of images based only on which it is impossible to indicate a lesion that matches the definitive diagnosis, due to image noise or characteristics of an imaging device. There is a high possibility that it is difficult to estimate a lesion based only on such image data items. Thus, presentation of such data items as reference case data items may increase the risk of a misdiagnosis. In contrast, the case data items in each of which image findings and a definitive diagnosis match are case data items which guarantee that it is possible to point out the same lesion as in the definitive diagnosis from the second interpretation target image data. Thus, by determining, as the search targets, only the case data items in which image findings and a definitive diagnosis match, it is possible to reduce the risk of a misdiagnosis.

In one general aspect, the techniques disclosed here feature a case searching apparatus includes: interpretation target obtaining unit configured to obtain an interpretation target image data item indicating an entirety of a medical image which is an interpretation target image or a part of the interpretation target image and a first image interpretation information item including a text data item indicating a user's interpretation of the interpretation target image data item, the part having a total number of pixels smaller than a total number of pixels of the entirety; an image similarity degree determining unit configured to determine an image similarity degree between the interpretation target image data item obtained by the interpretation target obtaining unit and an image data item indicating an entirety of a medical image or a part of the medical image included in one of case data items stored in a case database; a text similarity degree determining unit configured to determine a text similarity degree between the first image interpretation information item obtained by the interpretation target obtaining unit and a second image interpretation information item including a text data item indicating an interpretation of the image data item included in the case data item stored in the case database; a different-text case searching unit configured to narrow down the case data items stored in the case database to case data items whose image similarity degrees determined by the image similarity degree determining unit are larger than or equal to a threshold value for the image similarity degrees, and preferentially search out the one or more case data items in a descending order of image similarity degrees determined by the image similarity degree determining unit and an ascending order of text similarity degrees determined by the text similarity degree determining unit; and an output unit configured to output, to outside of the case searching apparatus, the one or more case data items searched out by the different-text case searching unit, wherein the threshold value for the image similarity degrees is determined according to the number of pixels of the interpretation target image data item obtained by the interpretation target obtaining unit.

In one general aspect, the techniques disclosed here feature a case testing apparatus includes: an interpretation target obtaining unit configured to obtain an interpretation target image data item indicating a medical image which is an interpretation target image and a first image interpretation information item including a text data item indicating a user's interpretation of the interpretation target image data item; an image similarity degree determining unit configured to determine an image similarity degree between the interpretation target image data item obtained by the interpretation target obtaining unit and an image data item indicating a medical image included in one of case data items stored in a case database; a text similarity degree determining unit configured to determine a text similarity degree between a set of the first image interpretation information item and a first diagnosis level which is determined based on the first image interpretation information item and a set of the second image interpretation information item and a second diagnosis level which is determined based on the second image interpretation information item, the first image interpretation information item being obtained by the interpretation target obtaining unit, the second image interpretation information item including a text data item indicating a user's interpretation of the image data item included in the case data item stored in the case database, each of the first and second diagnosis levels being an indicator of a classified disease stage, each of the first and second diagnosis levels being one of the following: (i) “No finding” indicating that there is no abnormal finding; (ii) “Follow-up” indicating that careful follow-up of a disease state is required; (iii) “Other test” indicating that an other test is required; and (iv) “Biopsy” indicating that a medical test using a microscope is required to examine an extracted part of a lesion; a different-text case searching unit configured to preferentially search out, from among the case data items stored in the case database, one or more case data items in a descending order of image similarity degrees determined by the image similarity degree determining unit and an ascending order of text similarity degrees determined by the text similarity degree determining unit; and an output unit configured to output, to outside of the case searching apparatus, the one or more case data items searched out by the different-text case searching unit.

In one general aspect, the techniques disclosed here feature a case testing apparatus includes: an interpretation target obtaining unit configured to obtain an interpretation target image data item indicating a medical image which is an interpretation target image and a first image interpretation information item including a text data item indicating a user's interpretation of the interpretation target image data item; an image similarity degree determining unit configured to determine an image similarity degree between the interpretation target image data item obtained by the interpretation target obtaining unit and an image data item indicating a medical image included in one of case data items stored in a case database; a text similarity degree determining unit configured to determine a text similarity degree between a set of the first image interpretation information item and a first diagnosis level determined based on the first image interpretation information item and a set of the second image interpretation information item and a second diagnosis level determined based on the second image interpretation information item, the first image interpretation information item being obtained by the interpretation target obtaining unit, the second image interpretation information item including a text data item indicating a user's interpretation of the image data item included in the case data item stored in the case database, each of the first and second diagnosis levels being an indicator of a classified disease stage, the first and second diagnosis levels including at least one of the following: (i) “No finding” indicating that there is no abnormal finding; (H) “Follow-up” indicating that careful follow-up of a disease state is required; (iii) “Other test” indicating that an other test is required; and (iv) “Biopsy” indicating that a medical test using a microscope is required to examine an extracted part of a lesion; a different-text case searching unit configured to preferentially search out, from among the case data items stored in the case database, one or more case data items in a descending order of image similarity degrees determined by the image similarity degree determining unit and an ascending order of text similarity degrees determined by the text similarity degree determining unit; and an output unit configured to output, to outside of the case searching apparatus, the one or more case data items searched out by the different-text case searching unit.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Hereinafter, certain exemplary embodiments are described in greater detail with reference to the accompanying Drawings.

The exemplary embodiment described below shows a general example. The numerical values, shapes, materials, structural elements, the arrangement and connection of the structural elements, steps, the processing order of the steps etc. shown in the following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

Hereinafter, a case searching apparatus according to an embodiment of the present disclosure is described in detail with reference to the drawings.

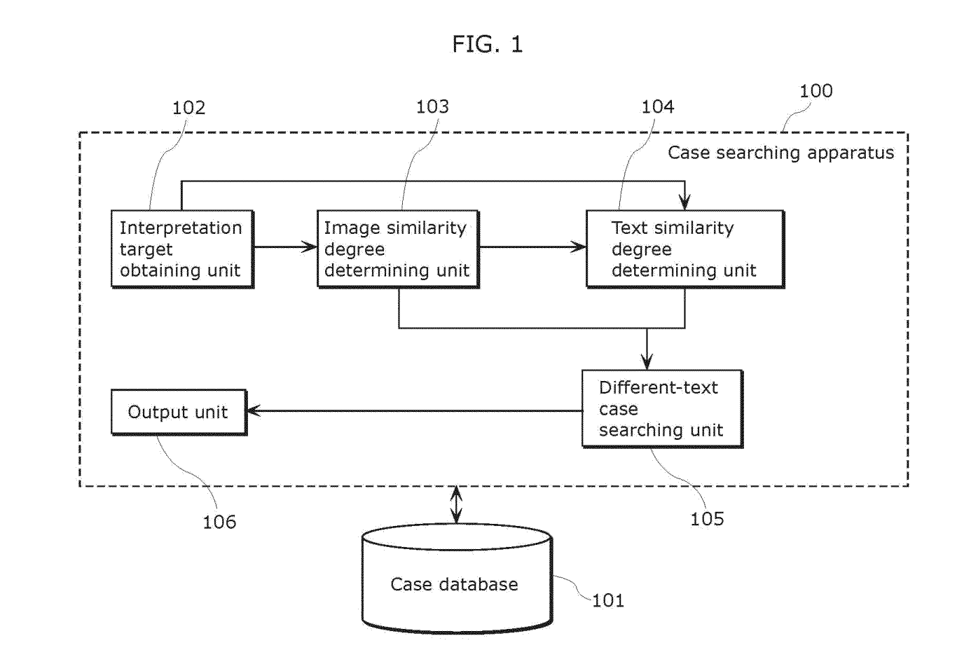

FIG. 1 is a block diagram showing a unique functional structure of a case searching apparatus 100 according to this embodiment.

As shown in FIG. 1, the case searching apparatus 100 is an apparatus which searches out a case data according to a result of image interpretation by a user.

The case searching apparatus 100 includes an interpretation target obtaining unit 102, an image similarity degree determining unit 103, a text similarity degree determining unit 104, a different-text case searching unit 105, and an output unit 106. It is assumed here that the case searching apparatus 100 is connected to a case database 101 prepared outside of the case searching apparatus 100. It is to be noted that the case searching apparatus 100 and the case database 101 do not always need to be placed at a same site. Thus, there is no restriction on the placement site as long as the case searching apparatus 100 and the case database 101 are connected via a network.

Hereinafter, detailed descriptions are sequentially given of structural elements of the case database 101 and the case searching apparatus 100.

The case database 101 is a storage device such as a hard disk and a memory. The case database 101 is a database storing case data items each including image data representing an image to be presented to the user and image interpretation information corresponding to the image data. Here, the image data is image data used for image-based diagnosis, and is stored in an electric medium. In addition, the image interpretation information is information indicating a result of interpreting the image data and a definitive diagnosis resulting from a biopsy performed after the image-based diagnosis. The image interpretation information is document data (text data). A biopsy is a medical test which is performed using a microscope or the like to examine an extracted part of a lesion.

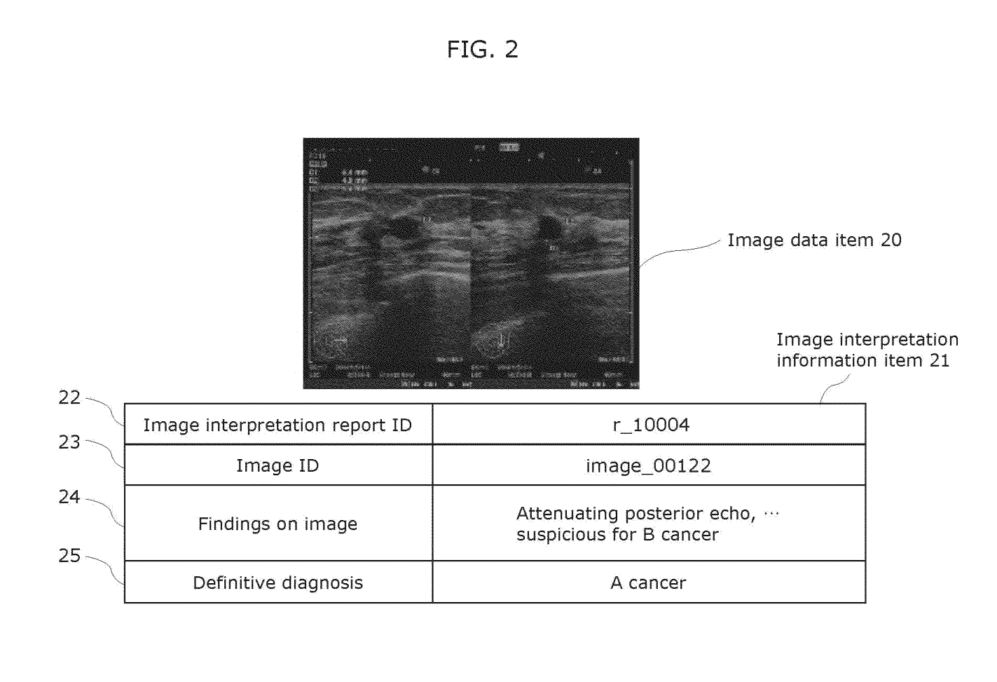

FIG. 2 shows an example of an ultrasonic image as an image data item 20 and an example of image interpretation information item 21 which are included in a case data item stored in the case database 101. The image interpretation information item 21 includes an image interpretation report ID 22, an image ID 23, image findings 24, and a definitive diagnosis 25.

The image interpretation report ID 22 is an identifier for identifying the image interpretation report (image interpretation information item 21). The image ID 23 is an identifier for identifying the image data item 20. The image findings 24 is information indicating a result of diagnosis based on the image data item 20 having the image ID 23. In other words, the image findings 24 are information indicating the result of the diagnosis including a disease name (the result of the image interpretation) and a basis for the diagnosis (a basis for the image interpretation). The definitive diagnosis 25 shows a definitive diagnosis for a patient indicated by the image interpretation report ID 22. Here, the definitive diagnosis is the final diagnosis result clearly showing the real state of the disease of the target patient by performing the pathological test using the microscope onto the test body obtained in the surgery or the biopsy or through the other various kinds of means.

The interpretation target obtaining unit 102 obtains, from the case database 101, the interpretation target image data item 20 and the image interpretation information item 21 used in the diagnosis by the user. For example, information input through a keyboard, a mouse, or the like is stored in a memory or the like. Next, the interpretation target obtaining unit 102 outputs the obtained interpretation target image data item and image interpretation information item to the image similarity degree determining unit 103 and the text similarity degree determining unit 104.

Next, the image similarity degree determining unit 103 determines an image similarity degree between the interpretation target image data item 20 obtained from the interpretation target obtaining unit 102 and each of image data items 20 stored in the case database 101, and notifies the different-text case searching unit 105 of the determined image similarity degree. A specific image similarity degree calculating method is described later.

Here, it is also good that a server (not shown) automatically calculates an image similarity degree at the time when the interpretation target image data item 20 is registered in the case database 101, and stores the calculated image similarity degree in the case database 101. In other words, the server may calculate the image similarity degree between the interpretation target image data item 20 to be registered in the case database 101 and each of image data items 20 already registered in the case database 101, and store the calculated image similarity degree in the case database 101. This eliminates the need to calculate an image similarity degree for each search of a case, which reduces time for a search process.

Next, the text similarity degree determining unit 104 determines a text similarity degree between the image interpretation information item 21 obtained from the interpretation target obtaining unit 102 and each of image interpretation information items 21 stored in the case database 101, and notifies the different-text case searching unit 105 of the determined text similarity degree. A specific text similarity degree calculating method is described later.

Here, it is also good that a server (not shown) automatically calculates a text similarity degree at the time when the image interpretation information item 21 is registered in the case database 101, and stores the calculated text similarity degree in the case database 101. In other words, the server may calculate the text similarity degree between the image interpretation information item 21 to be registered in the case database 101 and each of the image interpretation information items 21 already registered in the case database 101, and store the calculated text similarity degree in the case database 101. This eliminates the need to calculate a text similarity degree for each search of a case, which reduces time for a search process.

Next, the different-text case searching unit 105 calculates a text difference degree of an interpretation target report, based on the image similarity degree obtained from the image similarity degree determining unit 103 and the text similarity degree obtained from the text similarity degree determining unit 104. The different-text case searching unit 105 searches the case database 101 for a case data item, based on the calculated text difference degree. The different-text case searching unit 105 outputs the searched-out case data to the output unit 106. Here, the text difference degree is an indicator calculated based on the text similarity degree. A value indicating a higher text difference degree corresponds to a value indicating a higher image similarity degree, and a value indicating a lower text difference degree corresponds to a value indicating a lower image similarity degree. In other words, a value indicating a higher text difference degree shows that the images are similar in shape but the diagnoses are different. A specific text difference degree calculating method is described later.

Next, the output unit 106 outputs the case data item obtained from the different-text case searching unit 105 to an output-destination medium outside of the case searching apparatus 100. The output-destination medium is, for example, a monitor such as a liquid crystal display and a television screen. The user can check the case data when the case data item is output to the output-destination medium. Here, the output unit 106 may output the case data item as the search result to the output-destination medium via a network.

Next, descriptions are given of operations performed by the case searching apparatus 100 configured as described above.

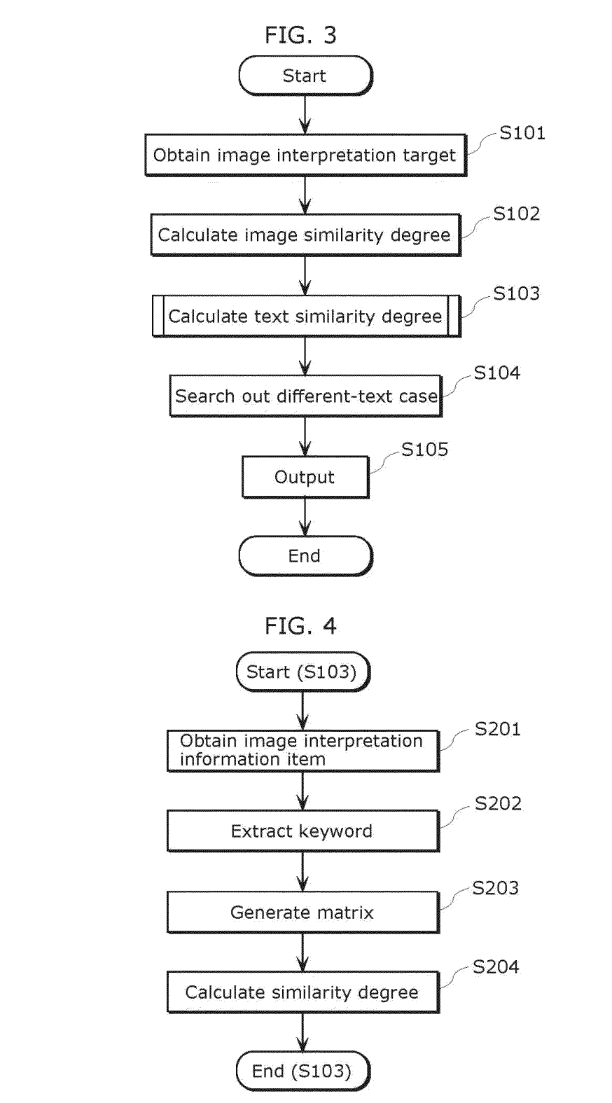

FIG. 3 is a flowchart of overall processes performed by the case searching apparatus 100.

First, the interpretation target obtaining unit 102 obtains, from the case database 101, an interpretation target image data item 20 and an image interpretation information item 21 made in a diagnosis by a user, and outputs them to the image similarity degree determining unit 103 (Step S101). It is good that the interpretation target image data item 20 and the image interpretation information item 21 are obtained after the completion of the diagnosis by the user. In this way, the user can automatically check different-text cases after the completion of the diagnosis.

Here, the interpretation target obtaining unit 102 may obtain mage data item of an area in the interpretation target image data item 20. More specifically, the user may select the area of the interpretation target image data item 20 using an input device such as a mouse, and obtain the pixel values of the selected image area as the interpretation target image data item 20. In this way, it is possible to evaluate image similarity according to the user's intention, and to thereby increase the accuracy in different-text case search.

In addition, the interpretation target obtaining unit 102 may obtain the image interpretation data item 20 and the image interpretation information item 21 of an arbitrary case selected by the user even if the case is the one diagnosed by persons other than the user as longs as the case has been already stored in the case database 101. In this way, the user can check other confusing cases using the cases diagnosed by the persons other than the user. Therefore, it is possible to increase the learning efficiency of image interpretation patterns by the user.

Next, the image similarity degree determining unit 103 determines an image similarity degree between the interpretation target image data item 20 obtained from the interpretation target obtaining unit 102 and the image data item 20 stored in the case database 101, and notifies the different-text case searching unit 105 of the determined image similarity degree (Step S102).

For example, it is good to calculate, as a similarity degree, an inverse number of Euclidean distance of image features between the interpretation target image and each of the other images, regarding, as image feature quantities, appearance frequencies of luminance patterns in local areas in the images (see Non-patent Literature 1: Kuriyama et. al, “False-Positive Elimination for Mass Detection System on Mammograms Using Image Retrieval Approach”, The Transactions of the Institute of Electronics, Information and Communication Engineers, vol. J87-D2, No. 1, pp, 353-356, 2004).

Next, the text similarity degree determining unit 104 calculates and determines a text similarity degree between the image interpretation information item 21 obtained from the interpretation target obtaining unit 102 and the image interpretation information item 21 stored in the case database 101, and notifies the different-text case searching unit 105 of the determined text similarity degree (Step S103).

FIG. 4 is a flowchart of detailed processes of a text similarity degree calculation process (Step S103 in FIG. 3) performed by the text similarity degree determining unit 104. Hereinafter, the text similarity degree calculation process is described with reference to FIG. 4.

First, the text similarity degree determining unit 104 obtains the image interpretation information item 21 from the case database 101 and the interpretation target obtaining unit 102 (Step S201).

Next, the text similarity degree determining unit 104 extracts keywords from a text item in the image interpretation information item 21 obtained in Step S201 (Step S202). For example, in the example shown in FIG. 2, the text similarity degree determining unit 104 may extract keywords from image findings 24 included in the image interpretation information item 21. More specifically, the text similarity degree determining unit 104 may store, in advance, a list of keywords which are extraction targets, and extract keywords which correspond to (for example, which match) the keywords in the list. In addition, the text similarity degree determining unit 104 may extract keywords using a morpheme analysis tool (see Non-patent Literature 2: “Morphological Analysis System “ChaSen”” by Yuji Matsumoto, Information Processing, vol. 41, No. 11, pp, 1208-1214, 2000).

Next, the text similarity degree determining unit 104 generates a matrix of values using keywords extracted in Step S202 (Step S203). The matrix is a matrix in which image interpretation information items 21 and information items indicating frequencies of the keywords are associated. The keyword frequency information item may be an indicator associated with the number of content items to the corresponding keyword, and may be, for example, a Document Frequency (DF) value or an appearance frequency (here, the DF value indicates the number of documents in which the keyword appears).

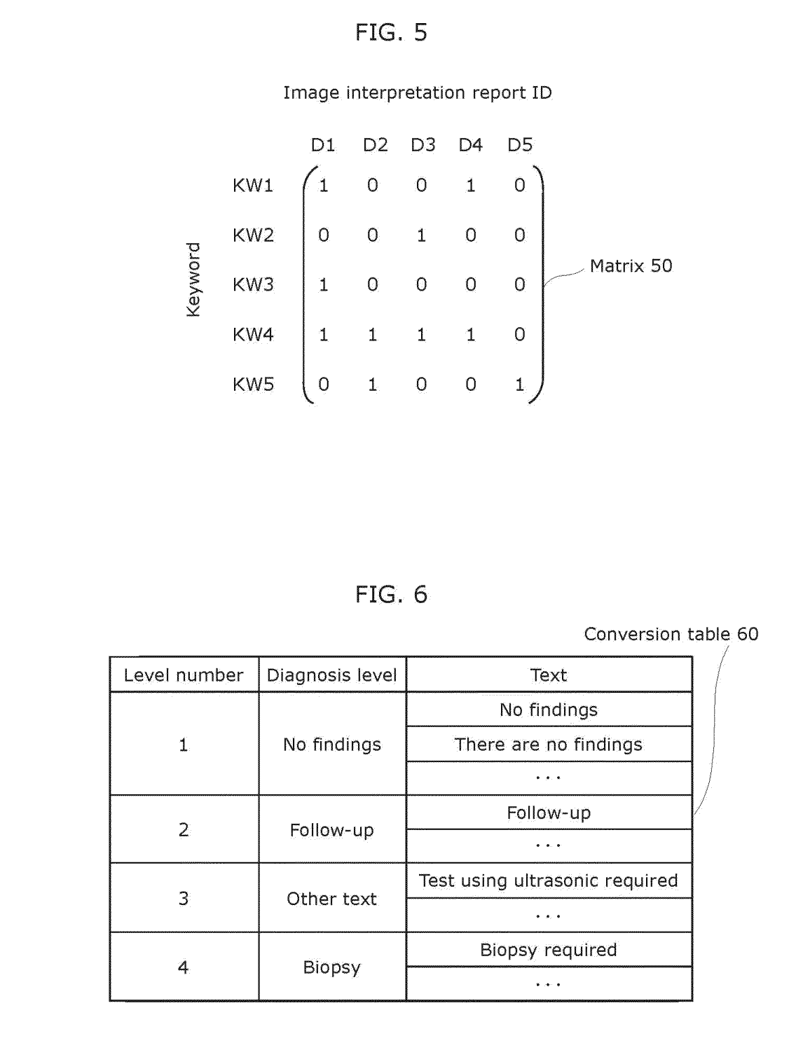

FIG. 5 shows an example of such a matrix. As shown in FIG. 5, the matrix 50 is a matrix of values representing searchable image interpretation report IDs 22 and keywords extracted from these content items. The values used in the matrix 50 may represent, for example, TF·IDF values or appearance frequencies. The TF·IDF values are keyword weight indicators which indicate exhaustivity (or exhausitivity) and specificity of keywords to the documents, and which are used for identifying to what degree the keywords which appear in the documents are characteristic. As for a specific method of calculating such TF·IDF values is disclosed by, for example, Non-patent Literature 3 “Language Processing and Information Retrieval” (pp. 32 to 33, University of Tokyo Press, 1999). For example, in the image interpretation information item 21 having an image interpretation report ID of D1, the TF·IDF values of keywords KW1, KW2, KW3, KW4, and KW5 are respectively shown as 1, 0, 1, and 0.

Next, the text similarity degree determining unit 104 calculates a similarity degree between image interpretation information items 21, using the matrix generated in Step S203 (Step S204). More specifically, the text similarity degree determining unit 104 may calculate, as the similarity degree, the cosine distance between a keyword vector of the image interpretation information item 21 obtained by the interpretation target obtaining unit 102 and a keyword vector of another image interpretation information item 21. For example, it is assumed that the image interpretation report ID 22 of the image interpretation information item 21 obtained by the interpretation target obtaining unit 102 is D1, and the image interpretation report IDs 22 of other image interpretation information items 21 included in case data items registered in the case database 101 are D2 to D5. For example, in the example of FIG. 5, the keyword vector having the image interpretation report ID 22 of D1 is (1, 0, 1, 1, 0), and the keyword vector having the image interpretation report ID 22 of D2 is (0, 0, 0, 1, 1). The text similarity degree determining unit 104 calculates a text similarity degree between the image interpretation information item 21 having the image interpretation report ID 22 of D1 and the image interpretation information item 21 having the image interpretation report ID 22 of D2, by calculating the cosine distance between the keyword vector (1, 0, 1, 1, 0) and the keyword vector (0, 0, 0, 1, 1). Likewise, the text similarity determining unit 104 calculates a text similarity degree between the image interpretation information item 21 having the image interpretation report ID 22 of D1 and each of the image interpretation report IDs 22 of other image interpretation information items 21 included in case data items registered in the case database 101 are D3 to D5.

By performing the above Steps S201 to S204, it is possible to calculate the text similarity degrees in Step S103.

Here, the text similarity degree determining unit 104 may calculate the similarity degrees after adding a large weight to a keyword corresponding to a disease name in the image findings 24. The disease name is an item corresponding to a conclusion in the image findings 24, and thus is an important keyword focused by the user. Thus, by calculating the text similarity degree with the weight to the keyword related to the disease name, it is possible to calculate the similarity degree based on the user's viewpoint. For example, when the keyword KW1 is assumed to be the keyword corresponding to the disease name in the matrix 50, it is also good to calculate the cosine distance after adding the weight, for example, by doubling the TF·IDF value to the keyword KW1, and to thereby calculate the text similarity degree. Here, whether or not the keyword corresponds to the disease name may be determined with reference to a disease name dictionary in which disease names are stored in advance.

In addition, the text similarity degree determining unit 104 may determine diagnosis levels based on the image interpretation information items 21, and calculate text similarity degrees using a matrix 50 to which the determined diagnosis levels are added, Diagnosis levels are classifications of treatments after image interpretation, and are classified disease stage indicators. For example, in general image interpretation processes, these diagnosis levels are classified into four which are “No findings”, “Follow-up”, “Other test”, and “Biopsy”. The diagnosis levels are keywords which correspond to the generic concepts of disease names and are as important as the disease names for the user because the keywords represent differences between cases. Here are provided definitions of these diagnosis levels. “No findings” is a diagnosis level indicating that there are no abnormal findings. “Follow-up” is a diagnosis level indicating that careful follow-up of a disease state is required. “Other test” is a diagnosis level indicating that an other test is required. “Biopsy” is a diagnosis level indicating that a medical test using a microscope or the like is required to examine an extracted part of a lesion.

As a method of determining one of the diagnosis levels, it is good to use a conversion table for converting a text item stored in the image interpretation information item 21 into a diagnosis level. FIG. 6 shows an example of a conversion table. As shown in FIG. 6, the conversion table 60 is a database in the form of a list of text items corresponding to diagnosis levels. The conversion table 60 may be prepared in advance by a system designer or may be automatically generated through a process such as clustering. For example, when the image findings 24 include a text data item of “No findings” or “There are no findings”, the diagnosis level of the image interpretation information item 21 is determined to be “No findings”. The use of the conversion table makes it possible to easily convert a text item into a diagnosis level.

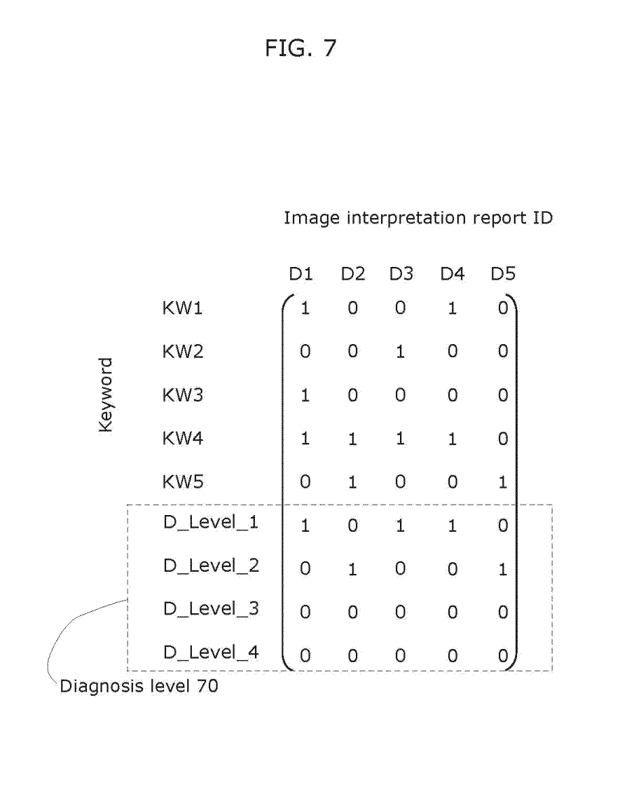

A specific method of calculating text similarity degrees is described below. The text similarity degree determining unit 104 determines a diagnosis level of a text item in the image interpretation information item 21 with reference to the conversion table 60. The text similarity degree determining unit 104 adds the determined diagnosis level as a keyword to the matrix 50, and calculates a text similarity degree according to the method described in Step S204. FIG. 7 shows an example of the matrix to which diagnosis levels are added. As shown in FIG. 7, the diagnosis levels 70 are added as keywords, and reflected in the similarity degree calculation. Through this process, it is possible to calculate the text similarity degrees reflecting the differences of the disease stages. For example, D_Level_{—}1 denotes the diagnosis level “No findings”, D_Level_{—}2 denotes “Follow-up”, D_Level_{—}3 denotes “Other test”, and D_Level_{—}4 denotes “Biopsy”.

With reference to FIG. 3 again, the different-text case searching unit 105 calculates a text difference degree of an interpretation target report, based on the image similarity degree obtained from the image similarity degree determining unit 103 and the text similarity degree obtained from the text similarity degree determining unit 104. The different-text case searching unit 105 searches out a case data item from the case database 101, based on the calculated text difference degree. The different-text case searching unit 105 outputs the searched-out case data item to the output unit 106 (Step S104).

More specifically, when an image similarity degree is a, a text similarity degree is β, and a threshold value related to the image similarity degree is th, a text difference degree γ can be calculated according to Expression 1.

### [Math.]

γ=α/β(α≧th) (Expression 1)

As shown in Expression 1, the text difference degree γ is an indicator which is in proportion to the image similarity degree α and in inverse proportion to the text similarity degree β. In other words, a value indicating a higher text difference degree shows that the images are similar in shape but the diagnoses are different. With the use of this value, the different-text case searching unit 105 can preferentially present a different-text case which is similar in image features but different in diagnosis. More specifically, the different-text searching unit 105 may search out a case data item having a text difference degree larger than a predetermined text difference degree or a predetermined number of case data items in a descending order of text difference degrees, from among the case data items stored in the case database 101. By defining the text difference degrees as such, it is possible to simultaneously evaluate the image similarity degrees and the text similarity degrees.

Here, the threshold value th for image similarity degrees may be set in advance by a system designer. Alternatively, a user may set the threshold value th arbitrarily.

Here, the threshold value for image similarity degrees used here may be a threshold value determined according to the number of pixels of the interpretation target image data item 20 obtained by the interpretation target obtaining unit 102. For example, when image similarity degrees are calculated for whole CT images, the average value of the image similarity degrees is a small value due to individual differences in the positions or sizes of organs or blood vessels in the CT images. On the other hand, when image similarity degrees are calculated for local areas (such as lesion areas of livers) in the CT images, the influence of individual differences in the positions or sizes of the organs or the blood vessels is small. For this reason, the average value of the image similarity degrees is relatively a large value. In this way, the average value of the image similarity degrees is different depending on the number of pixels of the interpretation target image data item 20. For this reason, if the threshold value th for the image similarity degree is set to a fixed value irrespective of the number of pixels of the interpretation target image data item 20 obtained by the interpretation target obtaining unit 102, different-text cases including case data items including image data items 20 represented using a large number of pixels are excluded from search targets or case data items including image data items 20 represented using a small number of pixels are all regarded as different-text case targets. To prevent this, the different-text case searching unit 105 sets the threshold value th for the image similarity degrees according to the number of pixels of the interpretation target image data items 20 obtained by the interpretation target obtaining unit 102.

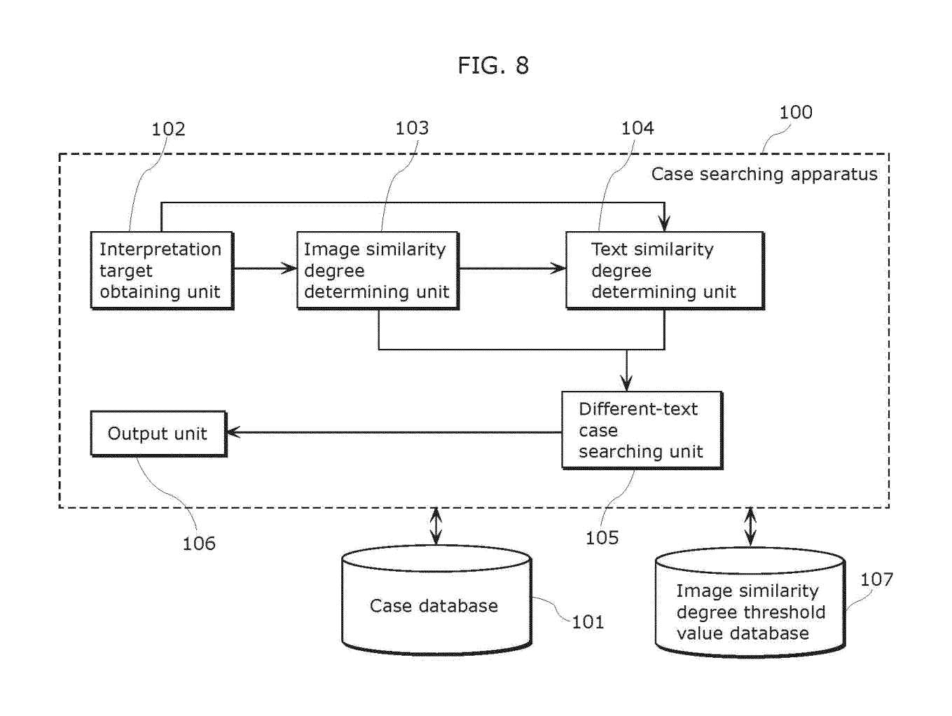

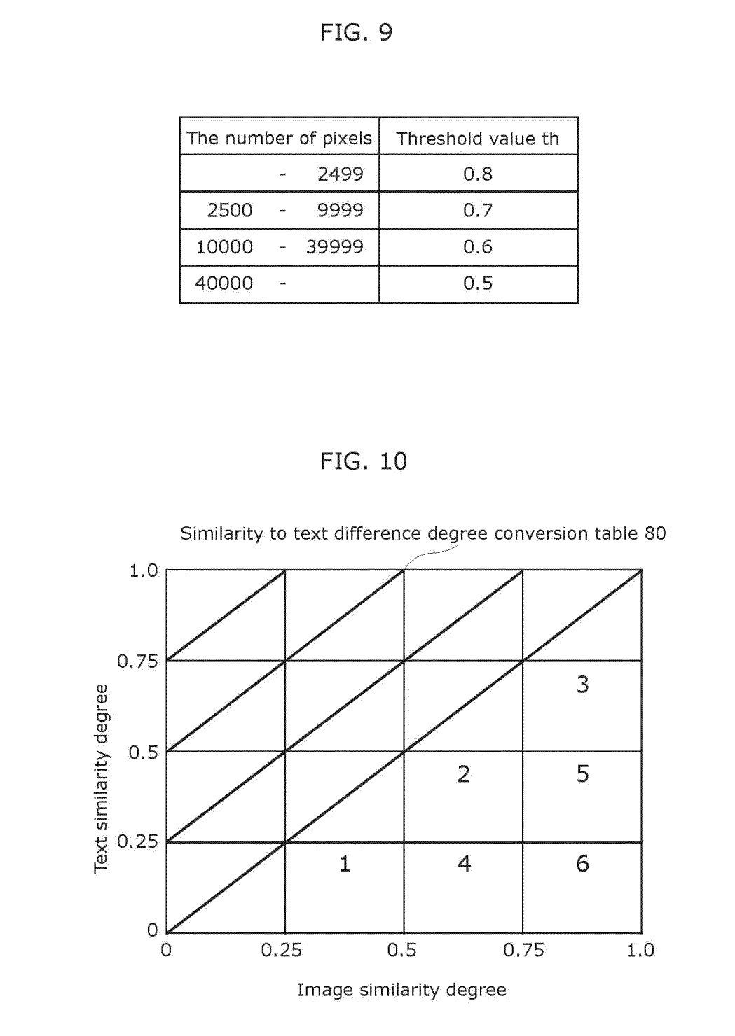

More specifically, as shown in FIG. 8, the different-text case searching unit 105 refers to the image similarity degree threshold value database 107 prepared outside of the case searching apparatus 100. FIG. 9 shows an example of data items stored in the image similarity degree threshold value database 107. In other words, FIG. 9 shows an example of data items showing associations between the numbers of pixels and the threshold values for the image similarity degrees. For example, a threshold value th of 0.8 is set for the interpretation target image data item 20 represented by 2499 pixels or less. In addition, a threshold value th of 0.7 is set for the interpretation target image data item 20 represented by a certain number of pixels within a range from 2500 to 9999. In this way, data items are defined such that the threshold values th are larger as the numbers of the pixels representing the interpretation target image data items 20 are smaller.

The different-text case searching unit 105 selects one of threshold values th which corresponds to the number of pixels of the interpretation target image data item 20 obtained by the interpretation target obtaining unit 102 with reference to the image similarity degree threshold value database 107 In this way, even when an arbitrary image area is selected by the interpretation target obtaining unit 102, it is possible to select the threshold value th appropriate for the size of the image area, and to thereby search out an appropriate different-text case.

As another method of calculating text difference degrees, it is also good to prepare in advance a conversion table for converting image similarity degrees and text similarity degrees into text difference degrees, and to calculate the text difference degrees with reference to the conversion table. FIG. 10 shows an example of a conversion table. As shown in FIG. 10, the text difference degree conversion table 80 stores descriptions of text difference degree values determined based on image similarity degree values and text similarity degree values. For example, when the image similarity degree is 0.8, and the text similarity degree is 0.1, the text difference degree is 6. The text difference degree conversion table 80 is only necessary to be a table in which a larger value is assigned to a smaller one of text similarity degrees associated with a corresponding one of the image similarity degrees. Here, the text difference degree values or the ranges of image similarity degrees and text similarity degrees representing the text difference degree values may be arbitrarily set according to the target cases.

In addition, the different-text case searching unit 105 may search out a different-text case from case data items including image interpretation information items which do not include a disease name included in the image interpretation information item 21 obtained from the image interpretation target obtaining unit 102 among the case data items stored in the case database 101. More specifically, the different-text case searching unit 105 compares the image interpretation information items 21 included in cases ranked based on text difference degrees shown in Expression 1 and the image interpretation information item 21 obtained by the interpretation target obtaining unit 102, and sets a smallest text difference degree value to a case including the same disease name. It is to be noted here that a small text similarity degree value may be calculated for a case including a description of the same disease name due to orthographical variants or a difference in the amount of descriptions (the number of keywords). In order to allow the user to check a plurality of confusing cases with reference to presented different-text cases, the different-text cases are desirably cases to which a disease name different from the disease name diagnosed by the user is assigned. Presentation of cases of diseases diagnosed as the disease diagnosed by the user inevitably increases time for reference to search results by the user. Thus, presentation of only different-text cases of diseases different from the disease diagnosed by the user reduces time for reference to search results by the user, which leads to reduce diagnosis time required for the user. It is to be noted that the different-text case searching unit 105 may determine the disease name in the image interpretation information item 21 with reference to a disease name dictionary in which disease names are stored in advance.

Next, the output unit 106 outputs the case data item obtained from the different-text case searching unit 105 to an output-destination medium outside of the case searching apparatus 100 (Step S105).

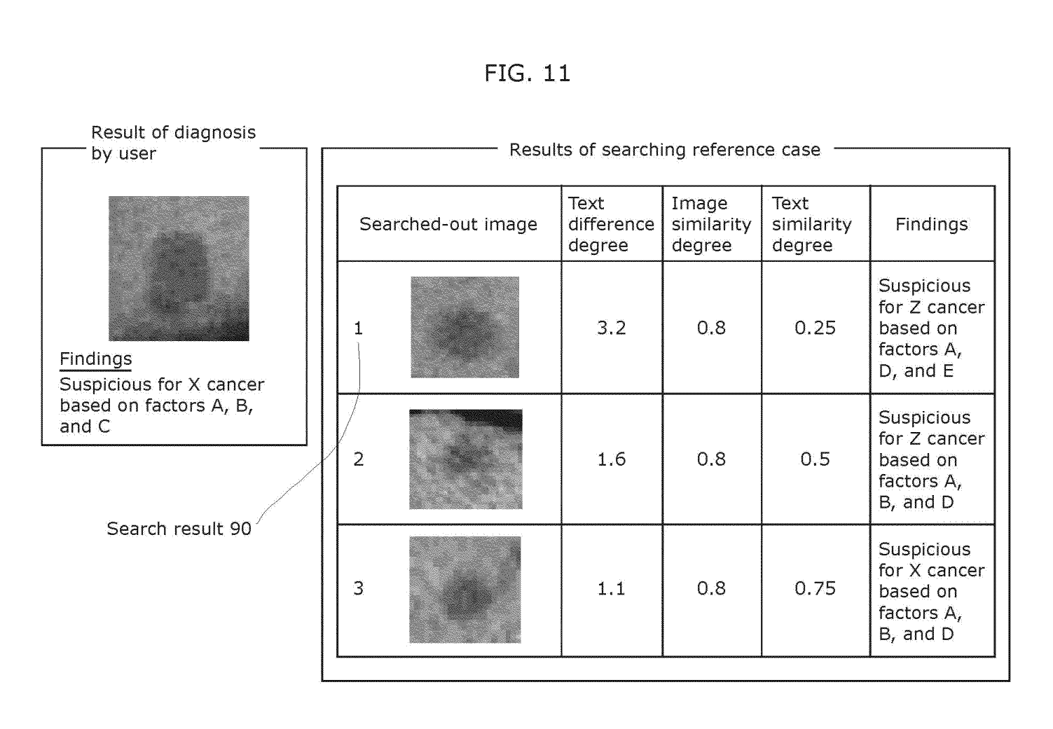

FIG. 11 is a diagram showing an example of a display screen output onto the output-destination medium by the output unit 106. As shown in FIG. 11, the output unit 106 presents similar cases in a descending order of text difference degrees for the diagnosis by the user. In the search result 90 in FIG. 11, the image similarity degree is 0.8, and the text similarity degree is 0.25, and thus the text difference degree can be calculated as 3.2 according to the earlier presented Expression 1. Since this case has a text difference degree value larger than those of the other cases, this case is searched out at the highest rank.

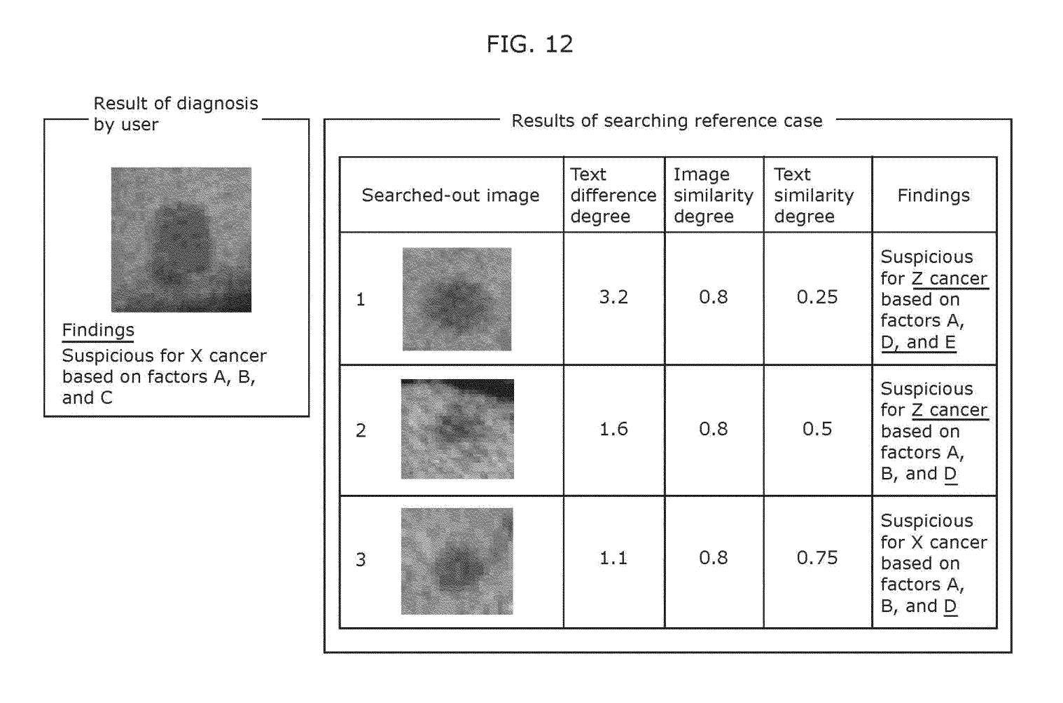

Here, the output unit 106 may display with emphasis the differences in the image findings 24 and image data items 20 between the case diagnosed by the user and the case searched out by the different-text case searching unit 105. FIG. 12 is an emphasized version of the output example in FIG. 11, in which the differences in image findings are displayed with emphasis. The reason why the text difference degree values are different is that the mage findings 24 are different and the image data items 20 are also different. By outputting, in distinguishable modes, these differences, the user can easily check why the text difference degrees are calculated, and can reduce image interpretation time after the check.

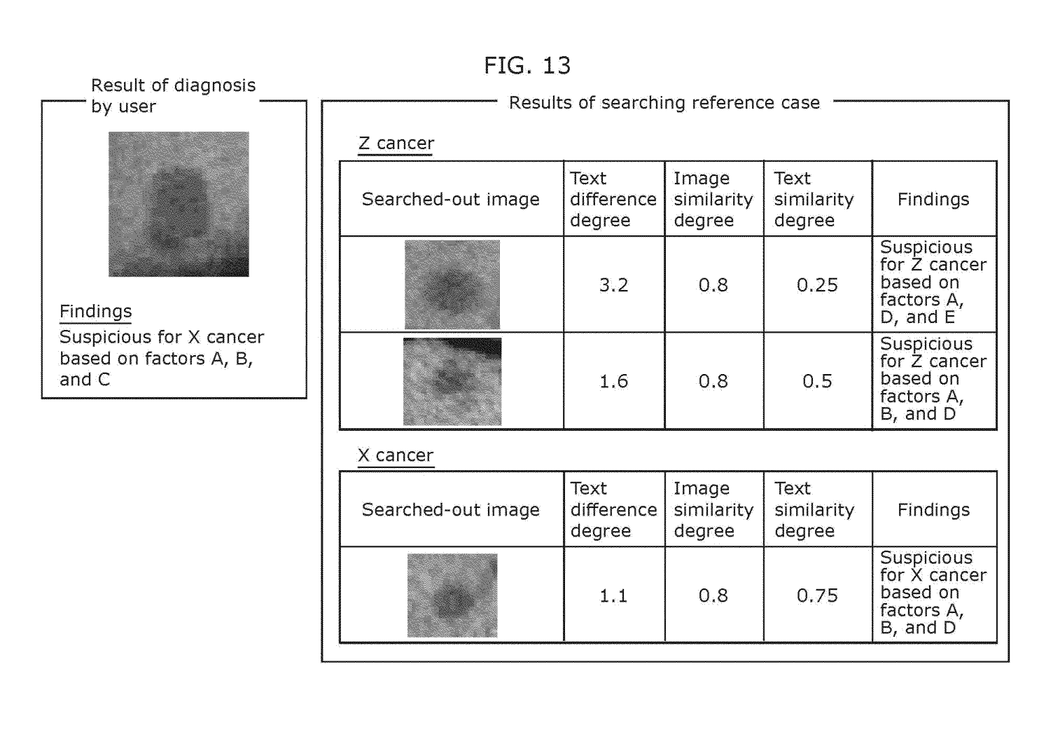

In addition, the output unit 106 may classify the cases searched out by the different-text case searching unit 105 into kinds of disease names, and display the cases based on the kinds. FIG. 13 shows a classified version of the output example in FIG. 11, in which the search results are classified into kinds of diseases and displayed based on the kinds. The user needs to find out a disease description different from the diagnosis by himself or herself from the findings in the search result when considering a possibility of a disease other than the disease diagnosed by himself or herself. By presenting the search results for each classified kind of disease names, the user can easily check the disease names in the cases presented as the search results, and can reduce image interpretation time.

As described above, by the execution of the processes of Steps S101 to S105 shown in FIG. 3, the case searching apparatus 100 can search out different-text cases having different diagnosis details for the diagnosis by the user with a small processing load.

Here, the image similarity degree and the text similarity degree may be normalized to have the same value range. Each similarity degree may take a different value range depending on a calculating method. In this case, a text difference degree is largely reflected on a similarity degree having a large value range, which results in a biased text difference indicator. The normalization makes it possible to handle the image similarity degrees and the text similarity degrees in a same manner, and to thereby correct the biased text difference degrees.

Alternatively, a user may set the similarity degree value range arbitrarily. In this way, it is possible to arbitrarily manipulate similarity degrees desired as focus targets. Thus, it is possible to reflect such a user's need of “wishing to increase the number of similar images more”, and to thereby increase the userfriendliness in search.

In addition, the interpretation target obtaining unit 102 does not always need to obtain an image data item 20 and an image interpretation information item 21 from the case database 101. For example, the interpretation target obtaining unit 102 may obtain the interpretation target image data item 20 interpreted just before by the user and image interpretation information item 21 thereof from another system.

In addition, the case searching apparatus 100 may search the case database 101 for only case data items in which image findings 24 and a definitive diagnosis 25 match as search targets. The case database 101 includes image data items of images based only on which it is impossible to indicate a lesion that matches the definitive diagnosis, due to image noise or characteristics of an imaging device. There is a high possibility that it is difficult to estimate a lesion based only on such image data items. Thus, presentation of such image data items as reference case data items may increase the risk of a misdiagnosis. In contrast, each of case data items in which image findings 24 and a definitive diagnosis 25 match is a case data item which guarantees that it is possible to point out the same lesion as the lesion in the definitive diagnosis from the image data item. Thus, the case data item is appropriate as a reference data item. Thus, by determining, as the search targets, only the case data items in which image findings 24 and a definitive diagnosis 25 match, it is possible to reduce the risk of a misdiagnosis.

In addition, the case database 101 may be included in the case searching apparatus 100.

In addition, the case database 101 may be included in a server connected to the case searching apparatus 100 via a network.

In addition, the image interpretation information item 21 may be included in the image data item 20 as an attached data item.

As described above, the case searching apparatus 100 according to this embodiment allows the user to easily check different-text cases including different diagnoses, and thus reduces the risk of a misdiagnosis by the user.

Although the case searching apparatus according to one embodiment of the present disclosure has been described above, the embodiment is a non-limiting exemplary embodiment. Those skilled in the art will readily appreciate that many modifications are possible in the exemplary embodiment and other embodiments are possible by arbitrarily combining the structural elements of the embodiment with others without materially departing from the novel teachings and advantages in the present disclosure. Accordingly, all such modifications are intended to be included within the scope of the present disclosure.

The aforementioned case searching apparatuses may be configured as a computer system including a microprocessor, a ROM, a RAM, a hard disk drive, a display unit, a keyboard, a mouse, and so on.

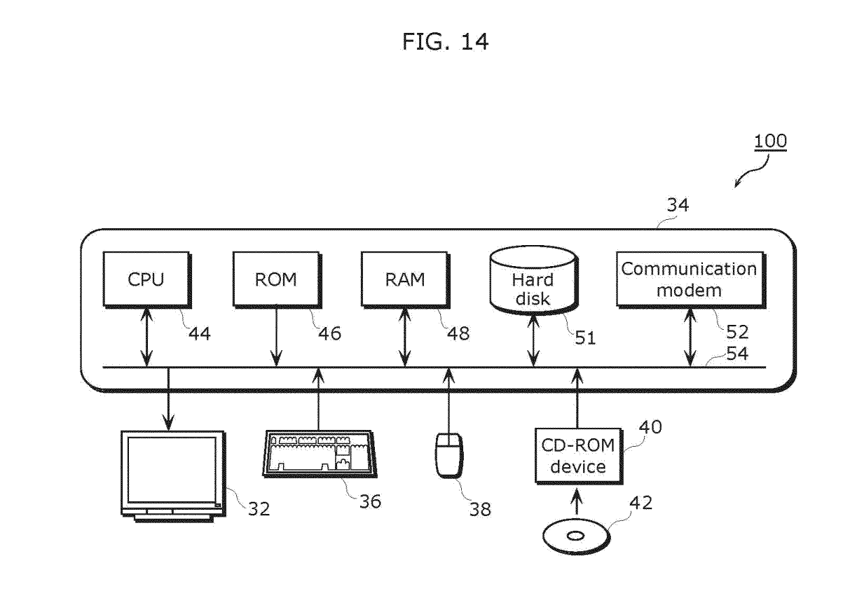

FIG. 14 is a block diagram showing a hardware structure of a computer system which realizes the case searching apparatus.

The case searching apparatus includes: a computer 34, a keyboard 36 and a mouse 38 for giving instructions to the computer 34, a display 32 for presenting information such as results of calculations by the computer 34, a Compact Disc-Read Only Memory (CD-ROM) device 40 for reading out a program to be executed by the computer 34, and a communication modern (not shown).

The program of processes which are performed by the case searching apparatus is stored in a CD-ROM 42 which is a computer-readable recording medium, and is read by the CD-ROM device 40, or is read by the communication modem 52 via a computer network.

The computer 34 includes a Central Processing Unit (CPU) 44, a Read Only Memory (ROM) 46, a Random Access Memory (RAM) 48, a hard disk 51, a communication modem 52, and a bus 54.

The CPU 44 executes the program read through the CD-ROM device 40 or the communication modem 52. The ROM 46 stores the program or data necessary for operations by the computer 34. The RAM 48 stores data such as parameters at the time of the execution of the program. The hard disc 51 stores the program or data, etc. The communication modem 52 communicates with other computers via a computer network. The bus 54 establishes mutual connections of the CPU 44, the ROM 46, the RAM 48, the hard disk 51, the communication modem 52, the display 32, the keyboard 36, the mouse 38, and the CD-ROM device 40.

Furthermore, some or all of the structural elements of the case searching apparatus may be configured with a single system Large Scale Integration (LSI). The system LSI is a super-multi-function LSI manufactured by integrating structural units on a single chip, and is specifically a computer system configured to include a microprocessor, a ROM, a RAM, and so on. The RAM stores a computer program. The system LSI achieves its function through the microprocessor's operations according to the computer program.

Furthermore, some or all of the structural elements constituting the case searching apparatus may be configured as an IC card which can be attached to and detached from the case searching apparatus or as a stand-alone module. The IC card or the module is a computer system composed of a microprocessor, a ROM, a RAM and so on. The IC card or the module may include the aforementioned super-multi-function LSI. The IC card or the module achieves its function through the microprocessor's operations according to the computer program. The IC card or the module may also be implemented to be tamper-resistant.

In addition, the present disclosure may be realized as the aforementioned case searching method including the following steps executed by a computer: obtaining an interpretation target image data item indicating a medical image which is an interpretation target image and a first image interpretation information item including a text data item indicating a user's interpretation of the interpretation target image data item; determining an image similarity degree between the interpretation target image data item obtained in the obtaining and an image data item indicating a medical image included in one of case data items stored in a case database; determining a text similarity degree between the first image interpretation information item obtained in the obtaining and a second image interpretation information item including a text data item indicating a user's interpretation of the image data item included in the case data item stored in the case database; preferentially searching out, from among the case data items stored in the case database, one or more case data items in a descending order of image similarity degrees determined in the determining of an image similarity degree and an ascending order of text similarity degrees determined in the determining of a text similarity degree; and outputting, to outside of the computer, the one or more case data items searched out in the searching.

In addition, the present disclosure may be realized as a computer program for causing a computer to execute the case searching method, or as a digital signal of the computer program. Each of the structural elements in the non-limiting exemplary embodiment may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or a semiconductor memory. Here, the software program for realizing the case searching apparatus according to the embodiment is a program described below. The program causes a computer to execute the case searching method including: obtaining an interpretation target image data item indicating a medical image which is an interpretation target image and a first image interpretation information item including a text data item indicating a user's interpretation of the interpretation target image data item; determining an image similarity degree between the interpretation target image data item obtained in the obtaining and an image data item indicating a medical image included in one of case data items stored in a case database; determining a text similarity degree between the first image interpretation information item obtained in the obtaining and a second image interpretation information item including a text data item indicating a user's interpretation of the image data item included in the case data item stored in the case database; preferentially searching out, from among the case data items stored in the case database, one or more case data items in a descending order of image similarity degrees determined in the determining of an image similarity degree and an ascending order of text similarity degrees determined in the determining of a text similarity degree; and outputting, to outside of the computer, the one or more case data items searched out in the searching.

Furthermore, the present disclosure may be realized as a non-transitory computer-readable recording medium having the computer program or the digital signal recorded thereon. Examples of the recording medium include a flexible disc, a hard disk, a CD-ROM, an MO, a DVD, a DVD-ROM, a DVD-RAM, a BD (Blu-ray (registered trademark) Disc), and a semiconductor memory. In addition, the present disclosure may be realized as the digital signal recorded on the non-transitory computer-readable recording medium.

Furthermore, the present disclosure may be realized as the aforementioned computer program or digital signal transmitted via a telecommunication line, a wireless or wired communication line, a network represented by the Internet, a data broadcast, and so on.

Furthermore, the present disclosure may be realized as a computer system including a microprocessor and a memory, in which the memory stores the aforementioned computer program and the microprocessor operates according to the computer program.

Furthermore, it is also possible to execute another independent computer system by transmitting the program or the digital signal recorded on the aforementioned non-transitory computer-readable recording media, or by transmitting the program or digital signal via the aforementioned network and the like.

The herein disclosed subject matter is to be considered descriptive and illustrative only, and the appended Claims are of a scope intended to cover and encompass not only the particular embodiment disclosed herein, but also equivalent structures, methods, and/or uses.

### INDUSTRIAL APPLICABILITY

The case searching apparatus and the case searching method according to the non-limiting exemplary embodiment disclosed herein are applicable as a case searching apparatus and a case searching method for outputting similar cases having diagnostic details different from details in diagnoses made by users.

1. A case searching apparatus comprising:
an interpretation target obtaining unit configured to obtain an interpretation target image data item indicating a medical image which is an interpretation target image and a first image interpretation information item including a text data item indicating a user's interpretation of the interpretation target image data item;
an image similarity degree determining unit configured to determine an image similarity degree between the interpretation target image data item obtained by the interpretation target obtaining unit and an image data item indicating a medical image included in one of case data items stored in a case database;
a text similarity degree determining unit configured to determine a text similarity degree between the first image interpretation information item obtained by the interpretation target obtaining unit and a second image interpretation information item including a text data item indicating an interpretation of the image data item included in the case data item stored in the case database;
a different-text case searching unit configured to preferentially search out, from among the case data items stored in the case database, one or more case data items in a descending order of image similarity degrees determined by the image similarity degree determining unit and an ascending order of text similarity degrees determined by the text similarity degree determining unit; and
an output unit configured to output, to outside of the case searching apparatus, the one or more case data items searched out by the different-text case searching unit.

2. The case searching apparatus according to claim 1,
wherein the different-text case searching unit is configured to search out, from among the case data items stored in the case database, the one or more case data items each of which has a value indicating a text difference degree and larger than a predetermined threshold value for text difference degrees, the value being obtained by dividing the image similarity degree determined by the image similarity degree determining unit by the text similarity degree determined by the text similarity degree determining unit.

3. The case searching apparatus according to claim 1,
wherein the different-text case searching unit is configured to narrow down the case data items stored in the case database to one or more case data items each including a second image interpretation information item which does not include a disease name included in the first image interpretation information item obtained by the interpretation target obtaining unit, and preferentially search out the one or more case data items in the descending order of the image similarity degrees determined by the image similarity degree determining unit and the ascending order of the text similarity degrees determined by the text similarity degree determining unit.

4. The case searching apparatus according to claim 1,
wherein the different-text case searching unit is configured to narrow down the case data items stored in the case database to one or more case data items whose image similarity degrees determined by the image similarity degree determining unit are larger than or equal to a threshold value for the image similarity degrees, and preferentially search out the one or more case data items in the descending order of the image similarity degrees determined by the image similarity degree determining unit and the ascending order of the text similarity degrees determined by the text similarity degree determining unit.

5. The case searching apparatus according to claim 4,
wherein the threshold value for the image similarity degrees is determined according to the number of pixels of the interpretation target image data item obtained by the interpretation target obtaining unit.

6. The case searching apparatus according to claim 5,
wherein the threshold value for the image similarity degrees increases with increase in the number of pixels of the interpretation target image data item obtained by the interpretation target obtaining unit.

7. The case searching apparatus according to claim 1,
wherein the text similarity degree determining unit is configured to add a large weight to a word related to a disease name, and determine a weighted text similarity degree between the first image interpretation information item and the second image interpretation information item.

8. The case searching apparatus according to claim 1,
wherein the text similarity degree determining unit is configured to determine a text similarity degree between a set of the first image interpretation information item and a first diagnosis level which is determined based on the first image interpretation information item and a set of the second image interpretation information item and a second diagnosis level which is determined based on the second image interpretation information item, each of the first and second diagnosis levels being an indicator of a classified disease stage.

9. The case searching apparatus according to claim 8,
wherein the text similarity degree determining unit is further configured to determine the diagnosis level from a text item included in each of the first image interpretation information item and the second image interpretation information item with reference to a conversion table for converting a text item included in an image interpretation information item to a diagnosis level.

10. A case searching apparatus comprising:
an interpretation target obtaining unit configured to obtain an interpretation target image data item indicating a medical image which is an interpretation target image and a first image interpretation information item including a text data item indicating a user's interpretation of the interpretation target image data item;
an image similarity degree determining unit configured to determine an image similarity degree between the interpretation target image data item obtained by the interpretation target obtaining unit and an image data item indicating a medical image included in one of case data items stored in a case database;
a text similarity degree determining unit configured to determine a text similarity degree between a set of the first image interpretation information item and a first diagnosis level which is determined based on the first image interpretation information item and a set of the second image interpretation information item and a second diagnosis level which is determined based on the second image interpretation information item, the first image interpretation information item being obtained by the interpretation target obtaining unit, the second image interpretation information item including a text data item indicating a user's interpretation of the image data item included in the case data item stored in the case database, each of the first and second diagnosis levels being an indicator of a classified disease stage, each of the first and second diagnosis levels being one of the following:
(i) “No finding” indicating that there is no abnormal finding;
(ii) “Follow-up” indicating that careful follow-up of a disease state is required;
(iii) “Other test” indicating that an other test is required; and
(iv) “Biopsy” indicating that a medical test using a microscope is required to examine an extracted part of a lesion;
a different-text case searching unit configured to preferentially search out, from among the case data items stored in the case database, one or more case data items in a descending order of image similarity degrees determined by the image similarity degree determining unit and an ascending order of text similarity degrees determined by the text similarity degree determining unit; and
an output unit configured to output, to outside of the case searching apparatus, the one or more case data items searched out by the different-text case searching unit.

11. The case searching apparatus according to claim 10,
wherein the output unit is configured to classify the one or more case data items searched out by the different-text case searching unit for each kind of disease names, and output the classified case data items to the outside of the case searching apparatus.

12. The case searching apparatus according to claim 10,
wherein the output unit is configured to output, in distinguishable modes, the first image interpretation information item obtained by the interpretation target obtaining unit and the second image interpretation information item included in each of the one or more case data items searched out by the different-text case searching unit.

13. The case searching apparatus according to claim 10,
wherein the different-text case searching unit is configured to search out the one or more case data items from case data items including a second image interpretation information item in which an image finding and a definitive diagnosis match among the case data items stored in the case database,
the image finding is obtained when the user makes a diagnosis based on the image data item included in the case data item, and
the definitive diagnosis is a definitive diagnosis made based on the image data item included in the case data item.

14. A case searching method comprising the following steps executed by a computer:
obtaining an interpretation target image data item indicating a medical image which is an interpretation target image and a first image interpretation information item including a text data item indicating a user's interpretation of the interpretation target image data item;
determining an image similarity degree between the interpretation target image data item obtained in the obtaining and an image data item indicating a medical image included in one of case data items stored in a case database;
determining a text similarity degree between a set of the first image interpretation information item and a first diagnosis level which is determined based on the first image interpretation information item and a set of the second image interpretation information item and a second diagnosis level which is determined based on the second image interpretation information item, the first image interpretation information item being obtained by the interpretation target obtaining unit, the second image interpretation information item including a text data item indicating a user's interpretation of the image data item included in the case data item stored in the case database, each of the first and second diagnosis levels being an indicator of a classified disease stage, each of the first and second diagnosis levels being one of the following:
(i) “No finding” indicating that there is no abnormal finding;
(ii) “Follow-up” indicating that careful follow-up of a disease state is required;
(iii) “Other test” indicating that an other test is required; and
(iv) “Biopsy” indicating that a medical test using a microscope is required to examine an extracted part of a lesion;
preferentially searching out, from among the case data items stored in the case database, one or more case data items in a descending order of image similarity degrees determined in the determining of an image similarity degree and an ascending order of text similarity degrees determined in the determining of a text similarity degree; and
outputting, to outside of the computer, the one or more case data items searched out in the searching.

15. A non-transitory computer-readable recording medium storing thereon a program for causing a computer to execute the following steps:
obtaining an interpretation target image data item indicating a medical image which is an interpretation target image and a first image interpretation information item including a text data item indicating a user's interpretation of the interpretation target image data item;
determining an image similarity degree between the interpretation target image data item obtained in the obtaining and an image data item indicating a medical image included in one of case data items stored in a case database;
determining a text similarity degree between a set of the first image interpretation information item and a first diagnosis level which is determined based on the first image interpretation information item and a set of the second image interpretation information item and a second diagnosis level which is determined based on the second image interpretation information item, the first image interpretation information item being obtained by the interpretation target obtaining unit, the second image interpretation information item including a text data item indicating a user's interpretation of the image data item included in the case data item stored in the case database, each of the first and second diagnosis levels being an indicator of a classified disease stage, each of the first and second diagnosis levels being one of the following:
(i) “No finding” indicating that there is no abnormal finding;
(ii) “Follow-up” indicating that careful follow-up of a disease state is required;
(iii) “Other test” indicating that an other test is required; and
(iv) “Biopsy” indicating that a medical test using a microscope is required to examine an extracted part of a lesion;
preferentially searching out, from among the case data items stored in the case database, one or more case data items in a descending order of image similarity degrees determined in the determining of an image similarity degree and an ascending order of text similarity degrees determined in the determining of a text similarity degree; and
outputting, to outside of the computer, the one or more case data items searched out in the searching.

16. A case searching apparatus comprising:
an interpretation target obtaining unit configured to obtain an interpretation target image data item indicating a medical image which is an interpretation target image and a first image interpretation information item including a text data item indicating a user's interpretation of the interpretation target image data item;
an image similarity degree determining unit configured to determine an image similarity degree between the interpretation target image data item obtained by the interpretation target obtaining unit and an image data item indicating a medical image included in one of case data items stored in a case database;
a text similarity degree determining unit configured to determine a text similarity degree between a set of the first image interpretation information item and a first diagnosis level determined based on the first image interpretation information item and a set of the second image interpretation information item and a second diagnosis level determined based on the second image interpretation information item, the first image interpretation information item being obtained by the interpretation target obtaining unit, the second image interpretation information item including a text data item indicating a user's interpretation of the image data item included in the case data item stored in the case database, each of the first and second diagnosis levels being an indicator of a classified disease stage, the first and second diagnosis levels including at least one of the following:
(i) “No finding” indicating that there is no abnormal finding;
(ii) “Follow-up” indicating that careful follow-up of a disease state is required;
(iii) “Other test” indicating that an other test is required; and
(iv) “Biopsy” indicating that a medical test using a microscope is required to examine an extracted part of a lesion;
a different-text case searching unit configured to preferentially search out, from among the case data items stored in the case database, one or more case data items in a descending order of image similarity degrees determined by the image similarity degree determining unit and an ascending order of text similarity degrees determined by the text similarity degree determining unit; and
an output unit configured to output, to outside of the case searching apparatus, the one or more case data items searched out by the different-text case searching unit.
